(19) United States
(12) Patent Application Publication
(10) Pub. No.: US 2026/0241702 A1
(43) Pub. Date: Aug. 20, 2026

(54) INKJET RECORDING APPARATUS

(71) Applicant: KYOCERA Document Solutions Inc., Osaka (JP)

(72) Inventors: Kohei YAMAKAMI, Osaka (JP); Takuma ARAKI, Osaka (JP)

(73) Assignee: KYOCERA Document Solutions Inc., Osaka (JP)

(21) Appl. No.: 19/542,796

(22) Filed: Feb. 18, 2026

(30) Foreign Application Priority Data
Feb. 19, 2025 (JP) 2025-024907

(51) Int. Cl. B41J 2/19; B41J 2/175; B41J 2/18

(52) U.S. Cl. CPC B41J 2/19; B41J 2/175; B41J 2/18

(57) ABSTRACT

An inkjet recording apparatus includes a recording head and an ink circulation portion including an ink storage container. The ink storage container includes a main body portion, a lid portion, an ink inflow port, an ink outflow port, and an air bubble discharge port. The ink circulation portion includes an ink storage container and a syringe. During an air bubble discharge process, the control portion makes the ink forcibly flow in through the ink inflow port and makes the ink flow out through the air bubble discharge port. During a printing process, the control portion makes the ink flow in through the ink inflow port and makes the ink flow in also through the air bubble discharge port.

### INCORPORATION BY REFERENCE

This application is based upon and claims the benefit of priority from the corresponding Japanese Patent Application No. 2025-024907 filed February 19, 2025, the entire contents of which are hereby incorporated by reference.

### BACKGROUND

The present disclosure relates to an inkjet recording apparatus.

An inkjet recording apparatus includes a recording head. The recording head ejects ink onto a recording medium such as a sheet and thereby forms an image on the recording medium.

In a conventional inkjet recording apparatus, ink is temporarily stored in an ink container. Then, the ink is fed from the ink container to a recording head.

### SUMMARY

According to one aspect of the present disclosure, an inkjet recording apparatus includes a recording head, an ink circulation portion, and a control portion. The recording head forms an image on a recording medium by ejecting ink onto the recording medium while receiving ink during a printing process. The ink circulation portion includes an ink storage container that stores ink. The ink storage container includes a main body portion, a lid portion, an ink inflow port, an ink outflow port, and an air bubble discharge port. The main body portion has a bottom portion and a side wall portion extending upward from the bottom portion and stores ink in a containing region that is a region surrounded by the bottom portion and the side wall portion. The lid portion is attached to the main body portion and covers the containing region from above. The ink inflow port allows ink to flow into the containing region. The ink outflow port is connected to the recording head and allows ink to flow out of the containing region to feed the ink to the recording head. Through the air bubble discharge port, air bubbles in the containing region are discharged. The ink circulation portion includes an ink storage container and a syringe. The ink storage container is connected to the ink inflow port and to the air bubble discharge port and stores ink. The syringe is disposed in an ink circulation path between the ink storage container and the ink inflow port. During an air bubble discharge process for discharging the air bubbles from the containing region, the control portion drives the syringe to push out the ink to make the ink forcibly flow through the ink inflow port into the containing region and to make the ink with air bubbles flow through the air bubble discharge port out toward the ink storage container. During a printing process, the control portion makes the ink flow through the ink inflow port into the containing region and makes the ink flow through the air bubble discharge port into the containing region.

### BRIEF DESCRIPTION OF THE DRAWINGS

FIG. 1 is a schematic diagram of an inkjet recording apparatus according to one embodiment.

FIG. 2 is a schematic diagram of a recording portion in the inkjet recording apparatus according to one embodiment.

FIG. 3 is a schematic diagram of an ink circulation portion according to one embodiment.

FIG. 4 is a perspective view of a mini tank according to one embodiment, as viewed from above.

FIG. 5 is a perspective view of the mini tank according to one embodiment, as viewed from below.

FIG. 6 is a sectional view of the mini tank according to one embodiment.

FIG. 7 is a diagram schematically illustrating the flow of ink (containing bubbles) in the mini tank according to one embodiment.

FIG. 8 is a diagram schematically illustrating the mini tank and conduits connected to it according to one embodiment.

FIG. 9 is a diagram illustrating ink circulation paths during a nozzle purge process performed on the inkjet recording apparatus according to one embodiment.

FIG. 10 is a diagram illustrating ink circulation paths during a head circulation purge process performed on the inkjet recording apparatus according to one embodiment.

FIG. 11 is a diagram illustrating ink circulation paths during a mini tank circulation purge process performed on the inkjet recording apparatus according to one embodiment.

FIG. 12 is a diagram illustrating ink circulation paths during a printing process performed on the inkjet recording apparatus according to one embodiment.

FIG. 13 is a plan view, as viewed from above, of the mini tank according to a modified example.

### DETAILED DESCRIPTION

### 1. Configuration of Inkjet Recording Apparatus

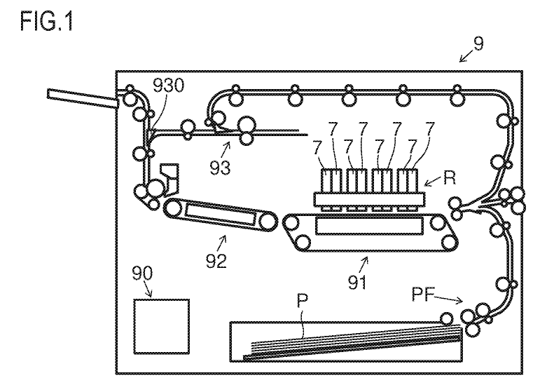

As shown in FIG. 1, an inkjet recording apparatus 9 according to one embodiment is an inkjet recording type printer. The inkjet recording apparatus 9 forms an image on a recording medium using ink. The recording medium is, for example, a sheet P of paper. However, this is not meant as a limitation; any other kinds of sheets, such as of cloth, can be used as the recording medium.

The inkjet recording apparatus 9 includes a recording portion R. The recording portion R forms an image at a recording position. The recording portion R ejects ink to the sheet P so as to form an image on the sheet P. In addition, the inkjet recording apparatus 9 includes a sheet feed portion PF, a first conveyance portion 91, and a second conveyance portion 92.

The sheet feed portion PF stores sheets P and feeds out one sheet P after another. The sheet feed portion PF conveys the sheet P to the recording position. The first and second conveyance portions 91 and 92 each have an endless belt stretched so as to be rotatable. The first and second conveyance portions 91 and 92 each hold the sheet P by sucking it onto the outer circumferential surface of the belt and, in this state, rotate the belts. In this way, the sheet P is conveyed.

The recording portion R is positioned above the first conveyance portion 91. The recording portion R forms an image on the sheet P being conveyed by the first conveyance portion 91. After image formation on the sheet P, the sheet P is fed from the first conveyance portion 91 to the second conveyance portion 92. While the second conveyance portion 92 is conveying the sheet P, the image (i.e., ink) formed on the sheet P is dried.

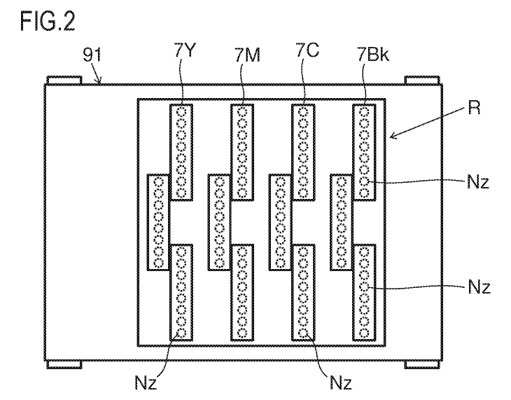

As shown in FIG. 2, the recording portion R includes three sets of recording heads 7Bk, 7C, 7M, and 7Y corresponding to black, cyan, magenta, and yellow colors respectively. In the following description, unless distinction is needed among the recording heads 7Bk, 7C, 7M, and 7Y, the suffixes at the end of these reference signs are omitted.

The recording heads 7 each have a plurality of ink ejection nozzles Nz. When printing is performed, the recording heads 7 receive ink while ejecting ink onto the sheet P being conveyed. In this way, an image is formed on the sheet P.

Note that as shown in FIG. 1, the inkjet recording apparatus 9 includes a reverse conveyance portion 93. When images are formed on both sides of the sheet P, after image formation on one side of the sheet P, a branch portion 930 guides the sheet P to the reverse conveyance portion 93. The reverse conveyance portion 93 switches back the sheet P and returns the sheet P to upstream of the recording position along the sheet conveyance direction. In this way, the front and back sides of the sheet P are reversed. In other words, image formation is now possible on the other side of the sheet P.

In addition, the inkjet recording apparatus 9 includes a control portion 90. The control portion 90 includes various electronic components such as a processing circuit (a CPU and the like) and a memory. The control portion 90 controls the operation of individual components of the inkjet recording apparatus 9 on the basis of control programs and control data.

### 2. Configuration of Ink Circulation Portion

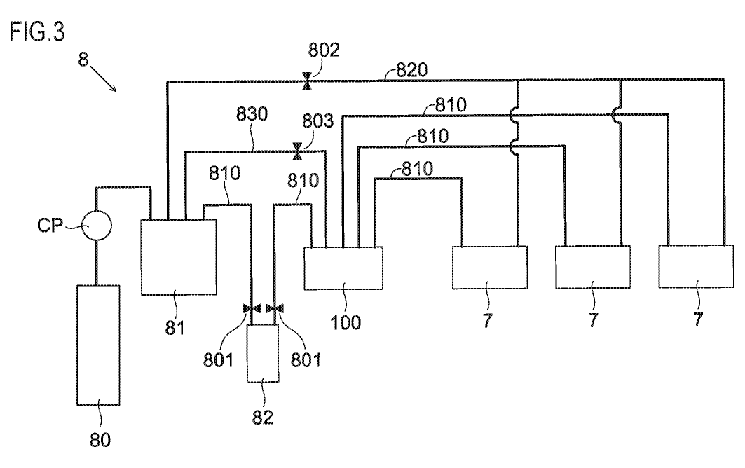

The inkjet recording apparatus 9 includes an ink circulation portion 8 as shown in FIG. 3. The ink circulation portion 8 is assigned to each of the colors of black, cyan, magenta, and yellow. In other words, the ink circulation portion 8 is assigned to each of the recording heads 7Bk, 7C, 7M, and 7Y.

Note that FIG. 3 only shows the ink circulation portion 8 for one color and the three recording heads 7 corresponding to it. The ink circulation portions 8 of individual colors have the same structure. Accordingly, for the configuration of the ink circulation portions 8 for the other colors, the following description is to be referred to and no overlapping description will be repeated.

### 2-1. Configuration of Mini Tank

The ink circulation portion 8 includes a mini tank 100. The mini tank 100 corresponds to an "ink storage container". The recording heads 7 are fed with ink from the same mini tank 100.

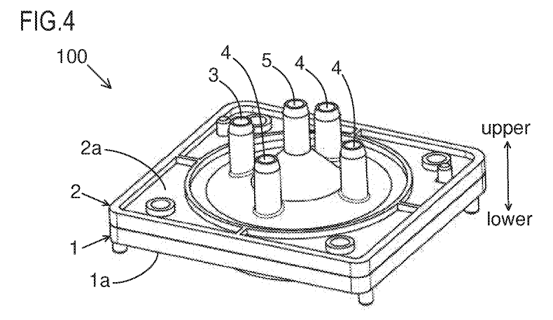

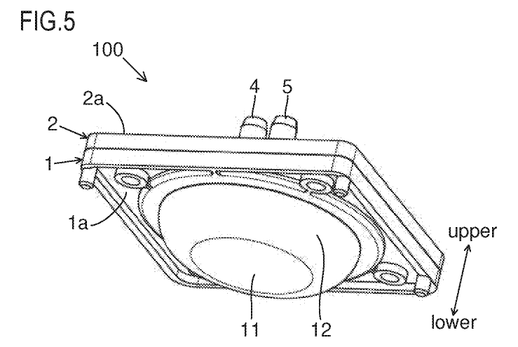

The configuration of the mini tank 100 will be described with reference to FIGS. 4 to 7. The mini tank 100 stores ink. The mini tank 100 has its up-down direction aligned with the vertical direction. The up-down direction of the mini tank 100 coincides with the up-down direction of the inkjet recording apparatus 9.

The mini tank 100 includes a main body portion 1 and a lid portion 2. The main body portion 1 and the lid portion 2 are each a resin molded product manufactured using a resin molding die. The main body portion 1 and the lid portion 2 are assembled together to constitute the mini tank 100. The main body portion 1 constitutes a lower part of the mini tank 100 and the lid portion 2 constitutes an upper part of the mini tank 100.

The main body portion 1 has a containing region 10 that stores ink. Specifically, the main body portion 1 has a bottom portion 11 and a side wall portion 12. The bottom portion 11 has a circular shape as viewed from the up-down direction. The side wall portion 12 extending upward, from an edge part of the bottom portion 11 as viewed in the up-down direction, around the entire circumference.

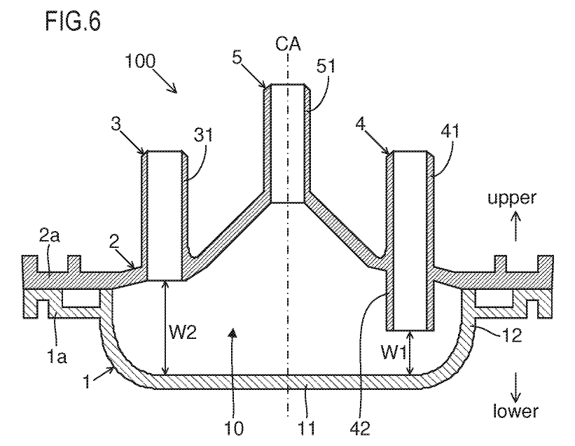

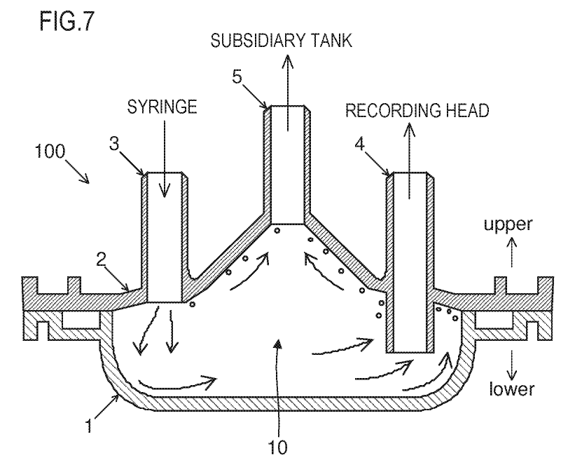

The containing region 10 is a region surrounded by the bottom portion 11 and the side wall portion 12. The containing region 10 is a region in a circular shape as viewed from the up-down direction. In FIG. 6, a center axis passing through the center of the containing region 10 as viewed from the up-down direction is identified by the reference sign CA. FIGS. 6 and 7 correspond to sectional views of the mini tank 100 as cut along a plane including the center axis CA.

The lid portion 2 is disposed above the main body portion 1. The lid portion 2 covers the containing region 10 from above. In other words, the lid portion 2 closes an upper opening of the main body portion 1.

The lid portion 2 is attached to the main body portion 1. Specifically, the main body portion 1 has a main body side attachment part 1a that surrounds the side wall portion 12 (i.e., the containing region 10) as viewed from the up-down direction. The main body side attachment part 1a has a contour in a substantially rectangular shape as viewed from the up-down direction. The lid portion 2 has a lid side attachment part 2a that overlaps with the main body side attachment part 1a in the up-down direction. The lid side attachment part 2a is fastened to the main body side attachment part 1a with a fastening member so that the lid portion 2 is attached to the main body portion 1.

The mini tank 100 includes an ink inflow port 3. The ink inflow port 3 is disposed in the lid portion 2. The ink inflow port 3 penetrates the lid portion 2 in the up-down direction to permit the inside and outside of the containing region 10 to communicate with each other. The ink inflow port 3 is the same member as the lid portion 2. In other words, the lid portion 2 integrally has the ink inflow port 3.

The ink inflow port 3 has an outer cylindrical portion 31 that projects in a cylindrical shape upward from the lid portion 2. The outer cylindrical portion 31 has a cylindrical shape and extends rectilinearly in the up-down direction. The ink inflow port 3 has an internal space of the outer cylindrical portion 31 as an ink flow passage. A conduit to pass the ink through is attached to a distal end part of the outer cylindrical portion 31. The ink inflow port 3 allows the ink in a subsidiary tank 81, which will be described later, to flow into the containing region 10.

The mini tank 100 includes an ink outflow port 4. The ink outflow port 4 is disposed in the lid portion 2. The ink outflow port 4 penetrates the lid portion 2 in the up-down direction to permit the inside and outside of the containing region 10 to communicate with each other. The ink outflow port 4 is the same member as the lid portion 2. In other words, the lid portion 2 integrally has the ink outflow port 4.

The ink outflow port 4 has an outer cylindrical portion 41 that projects in a cylindrical shape upward from the lid portion 2. The outer cylindrical portion 41 has a cylindrical shape and extends rectilinearly in the up-down direction. The ink outflow port 4 has an internal space of the outer cylindrical portion 41 as an ink flow passage. A conduit to pass the ink through is attached to a distal end part of the outer cylindrical portion 41. The ink outflow port 4 allows the ink to flow out from the containing region 10 to a recording head 7. That is, the ink outflow port 4 feeds the ink in the containing region 10 to the recording head 7. The recording head 7 forms an image using the ink fed from the mini tank 100.

Three recording heads 7 are assigned to each color. Thus, the mini tank 100 has three ink outflow ports 4 corresponding to the three recording heads 7, respectively. The three ink outflow ports 4 feed the ink to the corresponding recording heads 7.

The mini tank 100 includes an air bubble discharge port 5. The air bubble discharge port 5 is disposed in the lid portion 2. The air bubble discharge port 5 penetrates the lid portion 2 in the up-down direction to permit the inside and outside of the containing region 10 to communicate with each other. The air bubble discharge port 5 is the same member as the lid portion 2. In other words, the lid portion 2 integrally has the air bubble discharge port 5.

The air bubble discharge port 5 has an outer cylindrical portion 51 projects in a cylindrical shape upward from the lid portion 2. The outer cylindrical portion 51 has a cylindrical shape and extends rectilinearly in the up-down direction. The air bubble discharge port 5 has an internal space of the outer cylindrical portion 51 as an ink (with air bubbles) flow passage. A conduit to pass the ink through is attached to a distal end part of the outer cylindrical portion 51. The air bubble discharge port 5 discharges the air bubbles in the containing region 10 to a subsidiary tank 81, which will be described later.

If air bubbles flow into the recording head 7, ink ejection failure may occur, resulting in low image quality of the image formed using the ink. It is thus preferred to discharge the air bubbles in the containing region 10. To achieve that, the air bubble discharge port 5 is disposed in the mini tank 100. By discharging air bubbles in the containing region 10, it is possible to prevent the inflow of air bubbles into the recording head 7. For example, a mini tank circulation purge process, which will be described later, is performed to discharge the air bubbles in the containing region 10 through the air bubble discharge port 5.

The flow of the ink (with air bubbles) in the containing region 10 is schematically shown in FIG. 7. In FIG. 7, the flow of the ink (with air bubbles) is indicated by arrows. The air bubbles in the containing region 10 are indicated by small hollow circles. Note that in FIG. 7, the same reference signs as in FIG. 6 are used, with some reference signs omitted.

In this embodiment, the ink outflow port 4 has an inner cylindrical portion 42. The inner cylindrical portions 42 are provided one in each ink outflow port 4 and all have the same shape.

The inner cylindrical portion 42 projects in a cylindrical shape downward from the lid portion 2 and is disposed in the containing region 10. The inner cylindrical portion 42 has a cylindrical shape and extends rectilinearly in the up-down direction. The ink outflow port 4 has, in addition to the internal space of the outer cylindrical portion 41, an internal space of the inner cylindrical portion 42 as the ink flow passage. In other words, the internal space of the inner cylindrical portion 42 communicates with the internal space of the outer cylindrical portion 41. In still other words, the ink outflow port 4 has a cylindrical shape penetrating the lid portion 2 in the up-down direction.

Thus, in this embodiment, a lower-end opening of the inner cylindrical portion 42 is an opening of the ink outflow port 4 leading to the containing region 10. The ink in the containing region 10 flows into the internal space of the inner cylindrical portion 42 through the lower-end opening of the inner cylindrical portion 42 (i.e., the opening of the ink outflow port 4 leading to the containing region 10). Then, the ink in the containing region 10 flows out through an upper-end opening of the outer cylindrical portion 41 (i.e., an opening of the ink outflow port 4 opposite from the containing region 10).

In this configuration, the air bubbles in the containing region 10 tend to move upward, but it is difficult for the air bubbles to reach the opening of the ink outflow port 4 leading to the containing region 10 (i.e., the lower-end opening of the inner cylindrical portion 42); this prevents the inflow of air bubbles into the internal space of the inner cylindrical portion 42. It is thus possible to prevent air bubbles from flowing out through the ink outflow port 4. That is, it is possible to prevent air bubbles from flowing into the recording head 7.

Preventing the inflow of air bubbles into the recording head 7 helps prevent ink ejection failure in the recording head 7. In this way, it is possible to prevent degradation of the quality of the image formed using the ink.

Owing the ink outflow port 4 having the inner cylindrical portion 42, the opening of the ink outflow port 4 leading to the containing region 10 (i.e., the lower-end opening of the inner cylindrical portion 42) is disposed closer to the bottom portion 11 than the opening of the ink inflow port 3 leading to the containing region 10. In other words, the distance W1 between the opening of the ink outflow port 4 leading to the containing region 10 and the bottom portion 11 in the up-down direction is smaller than the distance W2 between the opening of the ink inflow port 3 leading to the containing region 10 side and the bottom portion 11 in the up-down direction.

In this configuration, it is difficult for the air bubbles around the opening of the ink inflow port 3 leading to the containing region 10 to reach the opening of the ink outflow port 4 leading to the containing region 10 (i.e., the lower-end opening of the inner cylindrical portion 42). In other words, the air bubbles move upward while moving from the ink inflow port 3 to the ink outflow port 4 and this makes it difficult for the ink to flow into the opening of the ink outflow port 4 leading to the containing region 10. It is thus possible to more effectively prevent air bubbles from flowing out through the ink outflow port 4.

In this embodiment, among the ink inflow port 3, the ink outflow port 4, and the air bubble discharge port 5, the ink outflow port 4 is located closest to the bottom portion 11 in the up-down direction and the air bubble discharge port 5 is located farthest from the bottom portion 11 in the up-down direction. That is, an opening of the air bubble discharge port 5 leading to the containing region 10 is disposed farther from the bottom portion 11 than the opening of the ink inflow port 3 leading to the containing region 10.

In this configuration, the air bubble discharge port 5 is disposed at a position in the containing region 10 where air bubbles tend to collect (i.e., the highest position). This makes it possible to efficiently discharge the air bubbles in the containing region 10 through the air bubble discharge port 5. For example, in the mini tank circulation purge process, which will be described later, it is possible to efficiently discharge the air bubbles in the containing region 10 through the air bubble discharge port 5. Efficient discharge of air bubbles through the air bubble discharge port 5 helps prevent air bubbles from flowing into the ink outflow port 4.

### 2-2. Ink Circulation Path

The ink circulation portion 8 circulates the ink. Thus, the ink circulation portion 8 feeds the ink to the recording heads 7. That is, the recording heads 7 are disposed in ink circulation paths in the ink circulation portion 8.

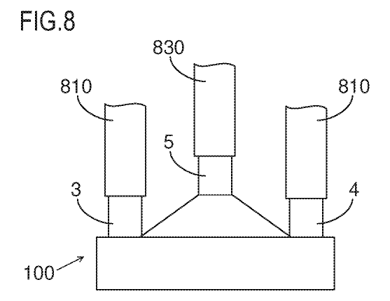

The ink circulation paths in the ink circulation portion 8 will be described with reference to FIGS. 3 to 8. FIG. 8 schematically shows the mini tank 100 and conduits connected to it.

The ink circulation portion 8 includes an ink container 80. The ink container 80 is removably mounted in the apparatus main body of the inkjet recording apparatus 9. The ink container 80 stores ink. In image formation on the sheet P by the inkjet recording apparatus 9, the ink in the ink container 80 is used.

The ink circulation portion 8 includes the subsidiary tank 81. The subsidiary tank 81 corresponds to an “ink storage container”. The ink circulates from the ink container 80 to the subsidiary tank 81. The subsidiary tank 81 temporarily stores the ink to be fed to the recording heads 7.

In the ink circulation path between the ink container 80 and the subsidiary tank 81, a container pump CP is disposed. The container pump CP sucks the ink in the ink container 80 and ejects the ink to the subsidiary tank 81. The subsidiary tank 81 temporarily stores the ink ejected from the container pump CP (i.e., the ink fed from the ink container 80).

The container pump CP is controlled by the control portion 90. For example, in the subsidiary tank 81, a stored ink amount sensor (not shown) is provided that outputs a value according to the amount of ink stored in the subsidiary tank 81. As the stored ink amount sensor, any of various sensors can be used such as sensors of optical, capacitive, electrode, differential pressure, and float types. The control portion 90 monitors the output value of the stored ink amount sensor. When the amount of ink stored in the subsidiary tank 81 falls below a predetermined amount, the control portion 90 uses the container pump CP to feed ink from the ink container 80 to the subsidiary tank 81.

The ink circulation portion 8 includes a syringe 82. The syringe 82 has, though not shown, a cylinder portion and a plunger disposed in the cylinder portion. For example, the syringe 82 has a rack gear that extends in its axial direction. The rack gear is disposed in the plunger. The syringe 82 has a pinion gear that meshes with the rack gear. The pinion gear is coupled to a syringe motor. When the syringe motor is driven, inside the cylindrical portion, the plunger moves in the axial direction. The syringe 82 moves the plunger in the axial direction to forcibly push out ink from inside to outside the cylindrical portion. The syringe motor is controlled by the control portion 90.

The ink circulation portion 8 includes first conduits 810. The first conduits 810 are, for example, tubes of rubber. The first conduits 810 are connected to the subsidiary tank 81. The first conduits 810 lead from the subsidiary tank 81 via the syringe 82 and the mini tank 100 to the recording heads 7.

The first conduits 810 include a conduit connected to the subsidiary tank 81 and to the cylinder portion of the syringe 82. The first conduits 810 include a conduit connected to the cylinder portion of the syringe 82 and to the ink inflow port 3.

The first conduits 810 include three conduits corresponding to the three ink outflow ports 4, respectively. In other words, the first conduits 810 include three conduits corresponding to the three recording heads 7, respectively. The three conduits are connected respectively to the corresponding ink outflow ports 4 and to the corresponding recording heads 7.

The first conduits 810 circulate the ink from the subsidiary tank 81 via the syringe 82 and the mini tank 100 to the recording heads 7. The recording heads 7 are fed with ink under a water head pressure.

The ink circulation portion 8 includes second conduits 820. The second conduits 820 are, for example, tubes of rubber. The second conduits 820 are connected to the subsidiary tank 81. The second conduits 820 are lead from the subsidiary tank 81 to the recording heads 7.

The second conduits 820 include three conduits corresponding to the three recording heads 7, respectively. The three conduits are connected to the subsidiary tank 81 and respectively to the corresponding recording heads 7.

The second conduits 820 circulate the ink from the subsidiary tank 81 to the recording heads 7. The recording heads 7 are fed with ink under a water head pressure.

The ink circulation portion 8 includes third conduits 830. The third conduits 830 are, for example, tubes of rubber. The third conduits 830 are connected to the air bubble discharge port 5 and to the subsidiary tank 81. Thus, the air bubbles (ink with air bubbles) in the containing regions 10, that is, the air bubbles discharged through the air bubble discharge ports 5 are returned to the subsidiary tank 81.

The ink circulation portion 8 includes a first on-off valve 801, a second on-off valve 802, and a third on-off valve 803. The first to third on-off valves 801 to 803 are disposed respectively in conduits through which ink is circulated and switch the corresponding conduits between an open and closed state. Opening the first to third on-off valves 801 to 803 permit the circulation of ink through the corresponding conduits, respectively. Closing the first to third on-off valves 801 to 803 shuts off the circulation of ink through the corresponding conduits, respectively.

The first to third on-off valves 801 to 803 have an identical configuration. The first to third on-off valves 801 to 803 each have a cam and an on-off valve motor coupled to the cam. The cams rotate to move between a closed position where they squeeze the corresponding conduits and an open position where they do not squeeze the corresponding conduits. The on-off valve motors are driven to rotate the cams. The on-off valve motors for the first to third on-off valves 801 to 803 are controlled by the control portion 90.

The first to third on-off valves 801 to 803 move to the closed position to squeeze the corresponding conduits and shut off the circulation of ink through the conduits. The first to third on-off valves 801 to 803 move to the open position to release the squeezing of the corresponding conduits and permit the circulation of ink through the conduits.

The first on-off valves 801 open and close the first conduits 810. There are two first on-off valves 801. One first on-off valve 801 is disposed in the segments of the first conduit 810 between the subsidiary tank 81 and the syringe 82. The other first on-off valve 801 is disposed in the segments of the first conduit 810 between the syringe 82 and the ink inflow port 3. Opening the first on-off valves 801 permit the circulation of ink from the subsidiary tank 81 via the syringe 82 and the mini tank 100 to the recording heads 7. It is thus possible to feed ink to the recording heads 7 via the first conduits 810.

While the ink in the subsidiary tank 81 is sucked into the syringe 82, the one first on-off valve 801 disposed between the subsidiary tank 81 and the syringe 82 is open and the other first on-off valve 801 disposed between the syringe 82 and the ink inflow port 3 is closed. While the ink in the syringe 82 is pushed out toward the mini tank 100, the one first on-off valve 801 is closed and the other first on-off valve 801 is open.

The second on-off valve 802 opens and closes the second conduits 820. The second on-off valve 802 is disposed in a part of the second conduits 820 between the subsidiary tank 81 and the recording heads 7. Opening the second on-off valve 802 permits the circulation of ink from the subsidiary tank 81 to the recording heads 7. It is thus possible to feed ink to the recording heads 7 via the second conduits 820.

The third on-off valve 803 opens and closes the third conduits 830. The third on-off valve 803 is disposed in a part of the third conduits 830 between the air bubble discharge port 5 and the subsidiary tank 81. Opening the third on-off valve 803 permits the circulation of ink from the mini tank 100 to the subsidiary tank 81. It is thus possible to discharge the ink with air bubbles in the containing region 10 through the air bubble discharge port 5 to the subsidiary tank 81.

According to what process is to be performed, the control portion 90 switches the ink circulation path in the ink circulation portion 8. That is, according to the what process is to be performed, the control portion 90 switches the first to third on-off valves 801 to 803 between the open and closed states.

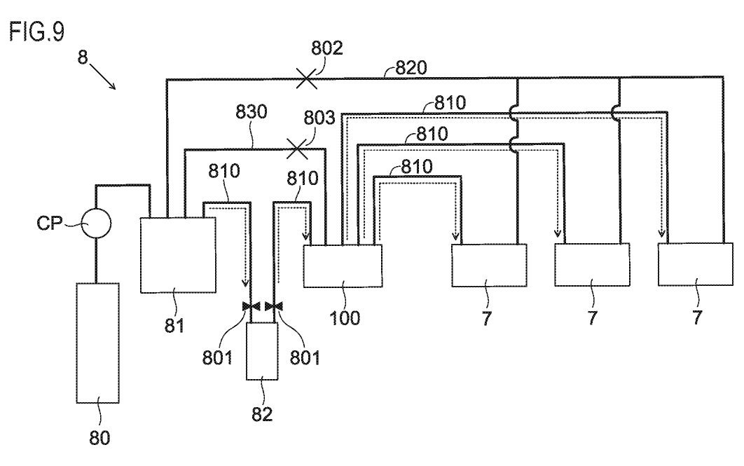

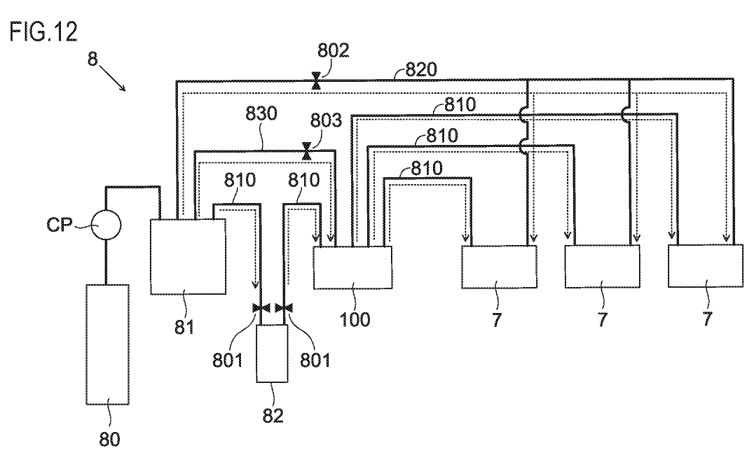

First, a purge process will be described with reference to FIGS. 9 to 11. In FIGS. 9 to 11, the ink circulation paths during the purge process are indicated by broken lines. The arrows of those broken lines indicate the ink circulation direction. In FIGS. 9 to 11, among the first to third on-off valves 801 to 803, the closed on-off valves are indicated by a cross sign. The same applies to FIG. 12, which will be referred to later.

FIG. 9 shows the ink circulation paths during a nozzle purge process. During the nozzle purge process, the control portion 90 keeps the second and third on-off valves 802 and 803 both closed. Then the control portion 90 drives the syringe 82 to push out the ink in the syringe 82. The control portion 90 sucks the ink from the subsidiary tank 81 into the syringe 82 and pushes the ink out of the syringe 82 toward the mini tank 100. Thus, the control portion 90 makes the ink forcibly flow through the ink inflow port 3 into the containing region 10 and makes the ink forcibly flow through the ink outflow port 4 out toward the recording heads 7. That is, the control portion 90 makes the ink forcibly flow into the recording heads 7.

Meanwhile, with the second on-off valve 802 closed, ink is forcibly discharged from the nozzles Nz of the recording heads 7. From the nozzles Nz of the recording heads 7, high-viscosity ink is also forcibly discharged. This helps prevent clogging in the nozzles Nz of the recording heads 7. This helps prevent ink ejection failure.

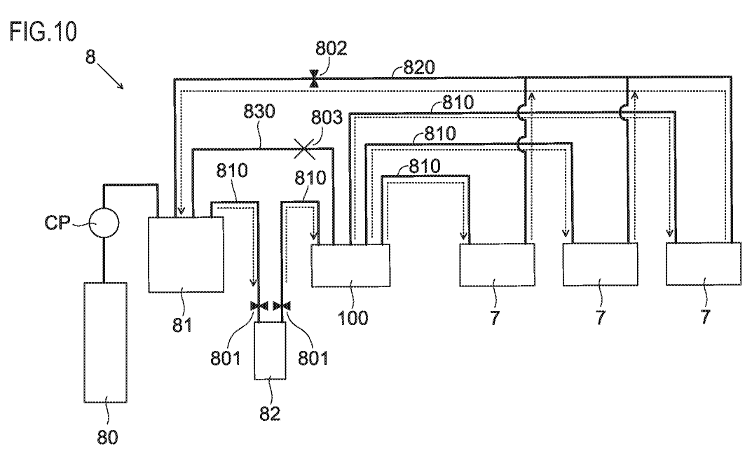

FIG. 10 shows the ink circulation paths during a head circulation purge process. During the head circulation purge process, the control portion 90 keeps the second on-off valve 802 open and keeps the third on-off valve 803 closed. Then the control portion 90 drives the syringe 82 to push out the ink in the syringe 82. The control portion 90 sucks the ink from the subsidiary tank 81 into the syringe 82 and pushes the ink out of the syringe 82 toward the mini tank 100. Thus, the control portion 90 makes the ink forcibly flow through the ink inflow port 3 into the containing region 10 and makes the ink forcibly flow through the ink outflow port 4 out toward the recording heads 7. That is, the control portion 90 makes the ink forcibly flow into the recording heads 7.

Meanwhile, with the second on-off valve 802 open, ink flow out of the recording heads 7 to the second conduits 820 and the ink circulates toward the subsidiary tank 81. In this way, the air bubbles remaining in the recording heads 7 can be discharged to the subsidiary tank 81. This helps prevent ink ejection failure.

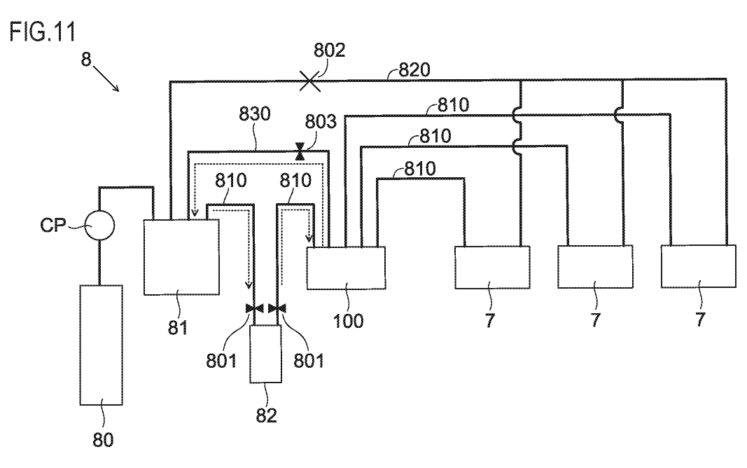

FIG. 11 shows the ink circulation paths during a mini tank circulation purge process. The mini tank circulation purge process corresponds to an “air bubble discharge process”. During the mini tank circulation purge process, the control portion 90 keeps the second on-off valve 802 closed and keeps the third on-off valve 803 open. Then the control portion 90 drives the syringe 82 to push out the ink in the syringe 82. The control portion 90 sucks the ink from the subsidiary tank 81 into the syringe 82 and pushes the ink out of the syringe 82 toward the mini tank 100. Thus, the control portion 90 makes the ink forcibly flow through the ink inflow port 3 into the containing region 10.

Meanwhile, with the third on-off valve 803 open, ink flows out through the air bubble discharge port 5 to the third conduits 830 and the ink circulates toward the subsidiary tank 81. Thus the air bubbles remaining in the containing region 10 can be discharged to the subsidiary tank 81. This prevents air bubbles from being mixed in the ink fed from the mini tank 100 to the recording heads 7. No air bubbles being mixed in the ink fed to the recording head 7 helps prevent ink ejection failure in the recording heads 7.

During the mini tank circulation purge process, a small amount of ink flows out also through the ink outflow port 4. That is, the ink flows into the recording heads 7. Thus, the ink may leak from the nozzles Nz of the recording heads 7.

Next, the ink circulation paths during a printing process by the recording heads 7 will be described with reference to FIG. 12.

During the printing process, the control portion 90 keeps the first to third on-off valves 801 to 803 all open. Thus, during the printing process, the ink circulates in the paths shown in FIG. 12. That is, during the printing process, the control portion 90 feeds ink to the recording heads 7 via the first and second conduits 810 and 820.

In this embodiment, during the printing process, with the third on-off valve 803 open, the ink can circulate through the third conduits 830, so the ink in the subsidiary tank 81 flows through the air bubble discharge port 5 into the containing region 10. That is, during the printing process, the control portion 90 makes the ink in the subsidiary tank 81 flow through the ink inflow port 3 into the containing region 10 and makes the ink in the subsidiary tank 81 flow through the air bubble discharge port 5 into the containing region 10.

In this embodiment, during the printing process, not only through the ink inflow port 3 but also through the air bubble discharge port 5, ink is fed to the containing region 10. This prevents insufficient feeding of ink to the mini tank 100 even if a large amount of ink is consumed in a short time in continuous printing with a high print ratio (printing of high-density images). This prevents ink ejection failure ascribable to insufficient feeding of ink from the mini tank 100 to the recording heads 7.

In this embodiment, the mini tank circulation purge process is performed to prevent air bubbles from remaining in the containing region 10. This prevents the inflow of air bubbles into the recording heads 7 and insufficient feeding of ink to the recording heads 7.

### 3. Modified Example

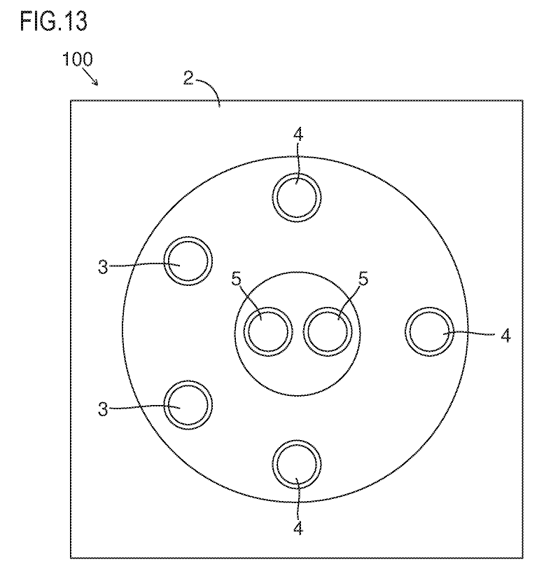

A modified example will be described below with reference to FIG. 13. FIG. 13 shows a plan view, as viewed from above (the axial direction of the center axis CA), of the mini tank 100. That is, FIG. 13 is a plan view of the lid portion 2.

In the modified example, the mini tank 100 includes a plurality of ink inflow ports 3. The mini tank 100 also includes a plurality of air bubble discharge ports 5. During the printing process, the control portion 90 makes the ink flow through each of the ink inflow ports 3 into the containing region 10 and makes the ink flow through each of the air bubble discharge ports 5 into the containing region 10.

In the modified example, the increased number of feeding paths for ink to the mini tank 100 during the printing process prevents insufficient feeding of ink to the mini tank 100. That is, it is possible to more effectively prevent insufficient feeding of ink to the recording heads 7.

While, in FIG. 13, two ink inflow ports 3 and two air bubble discharge ports 5 are provided , there is no particular limitation on the number of ink inflow ports 3 and air bubble discharge ports 5 to be provided. Although not shown, it is also possible to increase only ink inflow ports 3 or only air bubble discharge ports 5.

It should be understood that the above-described embodiments are in every aspect illustrative and not restrictive. The technical scope of the present disclosure is defined not by the description of the embodiments given above but by the appended claims, and encompasses any modifications made without departure from the scope and sense equivalent to those claims.

What is claimed is:

1. An inkjet recording apparatus, comprising:
a recording head that forms an image on a recording medium by ejecting ink onto the recording medium while receiving ink during a printing process;
an ink circulation portion that includes an ink storage container that stores ink; and
a control portion,
wherein
the ink storage container includes:
a main body portion that has a bottom portion and a side wall portion extending upward from the bottom portion, the main body portion storing ink in a containing region that is a region surrounded by the bottom portion and the side wall portion;
a lid portion attached to the main body portion, the lid portion covering the containing region from above,
an ink inflow port through which ink flows into the containing region;
an ink outflow port connected to the recording head, the ink flowing out of the containing region through the ink outflow port to be fed to the recording head; and
an air bubble discharge port through which air bubbles in the containing region are discharged, and
the ink circulation portion includes
an ink storage container connected to the ink inflow port and to the air bubble discharge port, the ink storage container storing ink, and
a syringe disposed in an ink circulation path between the ink storage container and the ink inflow port,
during an air bubble discharge process for discharging the air bubbles from the containing region, the control portion drives the syringe to push out the ink to make the ink forcibly flow through the ink inflow port into the containing region and to make the ink with air bubbles flow through the air bubble discharge port out toward the ink storage container, and
during the printing process, the control portion makes the ink flow through the ink inflow port into the containing region and makes the ink flow through the air bubble discharge port into the containing region.

2. The inkjet recording apparatus according to claim 1, wherein
the ink outflow port is disposed in the lid portion, and
the ink outflow port has an inner cylindrical portion that projects in a cylindrical shape downward from the lid portion and that is disposed in the containing region, the ink outflow port allowing the ink flowing in through a lower-end opening of the inner cylindrical portion to flow out to the recording head.

3. The inkjet recording apparatus according to claim 2, wherein
the ink inflow port is disposed in the lid portion, and
the lower-end opening of the inner cylindrical portion is disposed closer to the bottom portion than an opening of the ink inflow port leading to the containing region.

4. The inkjet recording apparatus according to claim 1, wherein
the air bubble discharge port is disposed in the lid portion, and
an opening of the air bubble discharge port leading to the containing region is disposed farther from the bottom portion than the openings of the ink inflow and outflow ports leading to the containing region.

5. The inkjet recording apparatus according to claim 1, wherein
the ink storage container includes a plurality of ink inflow ports, and
during the printing process, the control portion makes the ink flow through each of the ink inflow ports into the containing region.

6. The inkjet recording apparatus according to claim 1, wherein
the ink storage container includes a plurality of air bubble discharge ports, and
during the printing process, the control portion makes the ink flow through each of the air bubble discharge ports into the containing region.
